(19) United States
(12) Patent Application Publication
(10) Pub. No.: US 2024/0319039 A1
(43) Pub. Date: Sep. 26, 2024

(54) Monitoring Reference-Free Contact-Free Total Displacements And Movements With A UAS Equipped With Lasers And Computer-Vision

(71) Applicant: UNM Rainforest Innovations, Albuquerque, NM (US)

(72) Inventors: Fernando Moreu, Albuquerque, NM (US); Roya Nasimi, Albuquerque, NM (US)

(73) Assignee: UNM Rainforest Innovations, Albuquerque, NM (US)

(21) Appl. No.: 18/616,085

(22) Filed: Mar. 25, 2024

Related U.S. Application Data
(60) Provisional application No. 63/454,573, filed on Mar. 24, 2023.

(51) Int. Cl. G01M 5/00

(52) U.S. Cl. CPC G01M 5/0091; G01M 5/0008

(57) ABSTRACT

An Unmanned Aerial System (UAS) that enables the non-contact real-time displacement measurement of structures focusing on.

### RELATED APPLICATIONS

This application claims priority to U.S. Provisional Application No. 63/454,573, filed on Mar. 24, 2023, which is incorporated herein in its entirety.

### STATEMENT REGARDING FEDERALLY SPONSORED RESEARCH & DEVELOPMENT

This invention was made with government support by the Transportation Research Board grant 163418-0399. The government has certain rights in the invention.

### INCORPORATION BY REFERENCE OF MATERIAL SUBMITTED ON A COMPACT DISC

Not applicable.

### BACKGROUND OF THE INVENTION

Artificial intelligence (AI) enabled computer vision and robotics is leading engineers and managers to the next revolution in information modeling and decision making. More specifically, advances in sensors and the use of machines and vision-based approaches provide innovative solutions for the existing problems and changes the traditional structural health monitoring (SHM).

### BRIEF SUMMARY OF THE INVENTION

In one embodiment, the present invention concerns an Unmanned Aerial System (UAS) that enables the non-contact real-time displacement measurement of structures focusing on.

This new method uses a laser-camera system on a UAS to measure displacement.

In other embodiments, the present invention uses information from at least one camera to find the rotational angles that a laser experiences on a hovering UAS.

In other aspects, the present invention uses data from an additional accelerometer attached to a UAS to find the rotational angles that a laser experiences on a hovering UAS.

In other aspects, the present invention uses one or more cameras to find the translation motion that a laser experience on a hovering UAS.

In other aspects, the embodiments of the present invention can measure the out-of-plane displacement of structures in inaccessible zones, such as bridges, high buildings, and dams.

In other aspects, the present invention uses one or more lasers to collect relative displacements, but the signal can also inform of other physical indications of deterioration or vibration such as pseudo-static slope and displacements happening on the surface of interest relative to a reference-free (UAS) that is now positioned with this integrated approach.

Applications for the embodiments of the present invention include, but are not limited to: emergency monitoring during disaster events (fire, flooding, earthquakes), the performance of infrastructure under transportation systems, industrial facilities, energy facilities, offshore structures, oil industry, mine industry, city, and tall buildings monitoring, volcano activity, arctic exploration, forest and snow monitoring, ecology, wildlife monitoring and preservation, quality control of mechanical systems, and any reference-free contact-free monitoring needs where a drone can be situated as a reference without the need of tripods, scaffolds, structures, or physical rigid support to collect data.

In other aspects, the present invention uses a laser to collect important information of any physical phenomena of interest that needs to be obtained with a non-contact reference-free method, such as temperature, chemical information, corrosion, color, and density.

In other aspects, the present invention provides methods to measure the speed of water, which is needed to know in rivers, waterbeds, sea and needs a fixed reference, but can also be used to obtain the speed of moving particles such as soil, mud, snow, and lava from volcanos.

In other aspects, the present invention provides methods that can measure wildlife activity with a reference-free contact-free drone that can obtain the real movement, the velocity of wildlife with the integration of a laser and cameras.

In other aspects, the present invention provides a low-cost solution to fly with the drone and get the transverse displacement with the help of data collected by instrumentation attached on the drone, camera and laser.

In other aspects, the present invention provides a computer vision algorithm to convert the video collected from the camera to displacement. The computer vision algorithm may be validated by motion capture systems.

In other aspects, the present invention provides a displacement measuring system wherein displacement errors were 16.37 mm, 31.18 mm and 3.18 mm in X, Y and Z directions. Also, the percentage errors were 1.5%, 2.7%, and 3.6% in X, Y and Z directions, respectively.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 shows a UAS laser camera with cameras on the drone.

FIG. 2 shows a UAS laser camera with external cameras or positioning capture of the drone.

FIG. 3 shows a field implementation for an embodiment of the present invention.

FIG. 4 shows the algorithm's procedure to find dynamic displacement values of an object of interest such as a bridge.

FIG. 5 generally shows the pinhole camera model.

FIG. 6 provides a comparison between the present invention algorithm's estimation and the estimation of a VICON camera system (a) Displacement in X direction (b) Displacement in Y direction (c) Displacement on Z direction (d) 3D space view.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

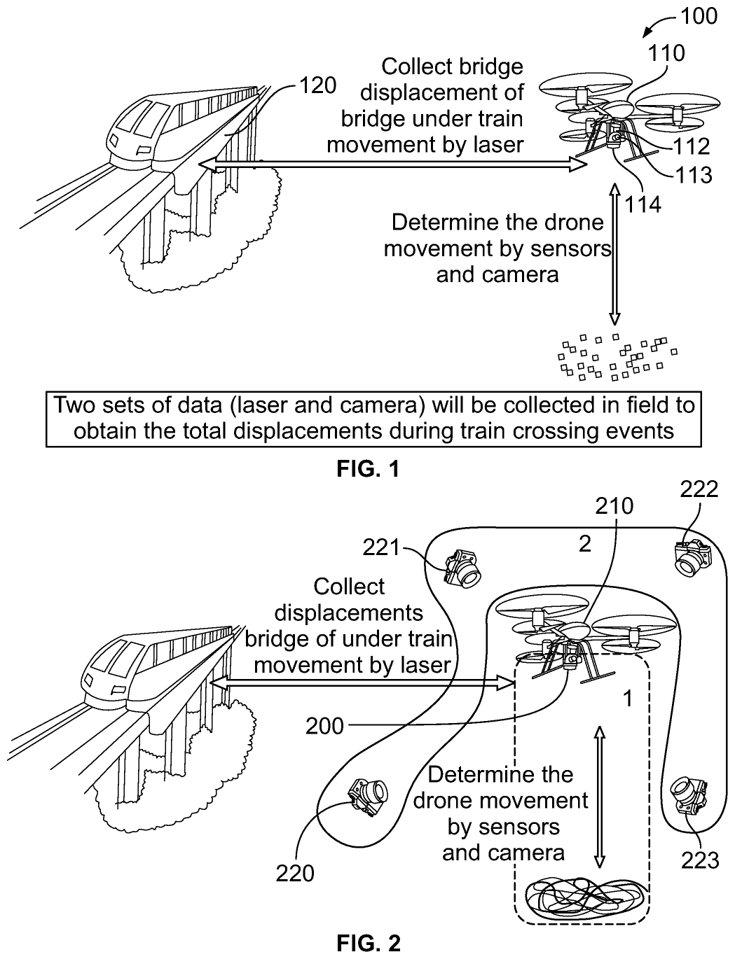

FIG. 1 illustrates one embodiment of the present invention. This embodiment provides system 100 which combines drone or Unmanned Arial Vehicles (UAV) 110, and one or more lasers 112, sensors 113, and at least one camera 114 to obtain the total displacement of the vibratory object 120, which may be a bridge. The combination of lasers (1 direction) and the position of the drone (6 degrees of freedom) which is determined by the fusion of two different sensors integrated into a flying access context to vibratory structures of interest. The camera under the drone or external cameras uses a reference object and reference frame to track both translational and rotational movement of the drone-camera-laser system during the experiment. First, the estimated rotational angels (Euler angles) were used to correct laser light and exclude the measurement deviations due to drone angle. Later the movement of the drone in direction of the laser light is synchronized and subtracted from the corrected laser measurement to provide absolute movement of the vibrating structure.

In addition to system 100 consisting of a drone, as well as a combination of sensors and lasers, the system may also include a computer vision algorithm to acquire the total displacement of the object of interest. The new integrated system mounted on the drone may use the pinhole camera model algorithm combined with a laser.

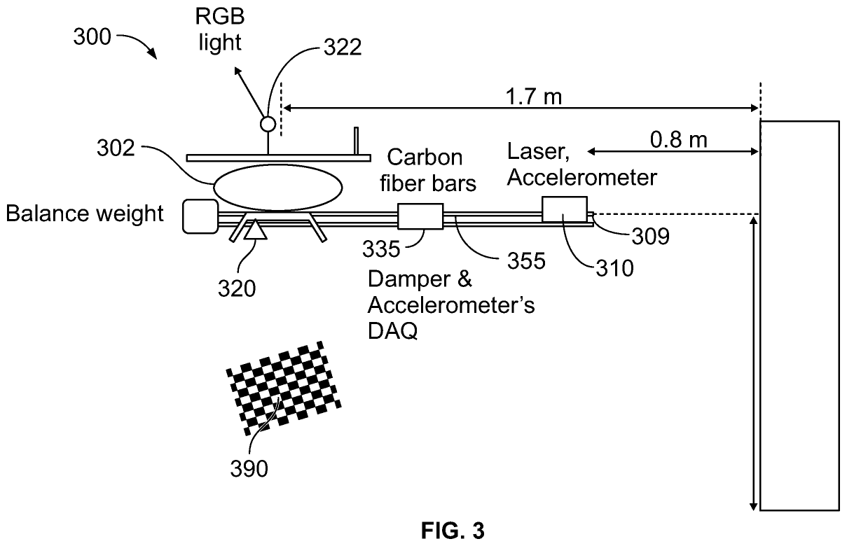

As shown in FIG. 2, to correct a signal concerning the distance between the drone and object generated by system 100 due to the movement or hovering of a drone, the present invention may use one or both of the following methods: (1) use a camera and sensor system 210 attached on UAS 220 to determine the UAS movement (2) or use one or more cameras 220-223 external to UAS 210 for filming and tracking UAS 210.

In other embodiments, the present invention includes an algorithm that uses a camera model and solves for displacements of the frames. Images used in this algorithm are distorted while in camera model they should be undistorted.

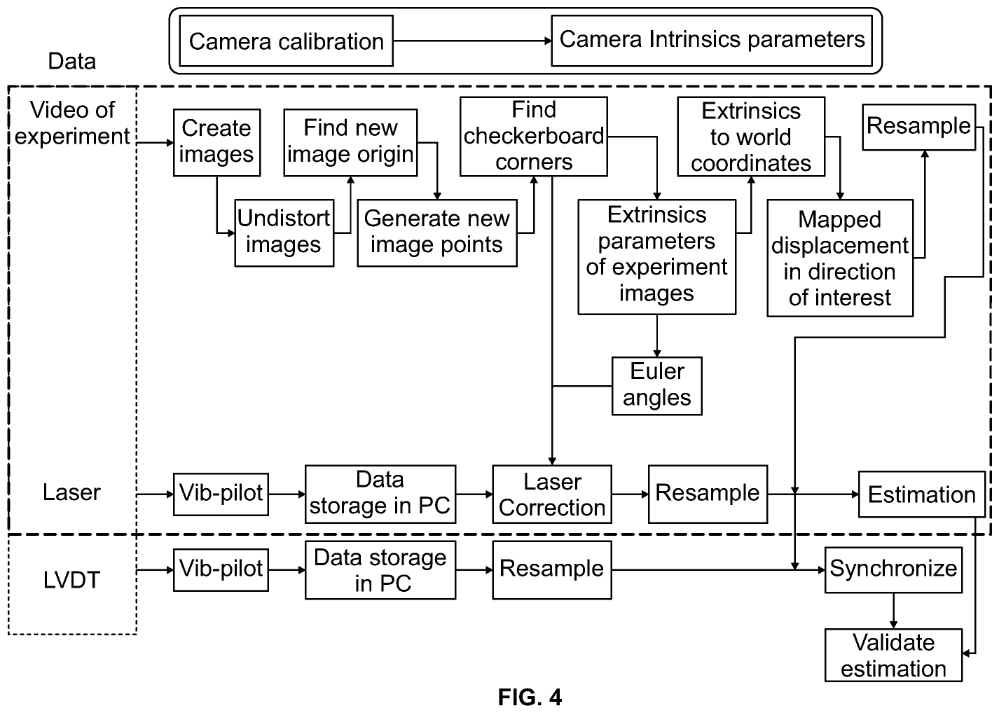

FIG. 3 shows a preferred embodiment of the present invention which provides measuring system 300 which includes UAV or drone 302, a laser 309 and at least one accelerometer 310. Also provided are camera 320, RGB light 322, and data acquisition system (DAQ) 335 for the laser and accelerometer. In a preferred embodiment, laser 309 has an accuracy of 0.1 mm and the range of 800 mm. The sensors and laser may be placed on the drone by means of carbon bars 355.

RGB light 322 receives input as to the distance drone 302 is from an object of interest to assist in properly positioning the drone a predetermined range from the object of interest. For example, if the predetermined range is 1-2 meters, the red light will be illuminated when the distance the drone is from the object is greater than 2 meters. For distances under 1 meter the blue light is activated. Lastly, when the drone is within an acceptable range, the green light is activated. This visible feedback assists in the proper positioning of the drone,

Table 1 gives the detailed list of the sensors and payload used in design of a preferred system as well as the payload.

TABLE 1
Estimated total load added to the drone.

| Component | Payload | |
|---|---|---|
| Laser | 135 | grams |
| Carbon bars | 226 | grams |
| Power supplies | 113 | grams |
| Camera | 290 | grams |
| DAQ system | 71 | grams |
| Acceleration system | 73 | grams |
| Amplifier and whole wire system | 150 | grams |
| Balance weight | 1000 | grams |
| 3D printed cases | 280 | grams |
| Strings | 158 | grams |
| Total | 2,496 | grams |

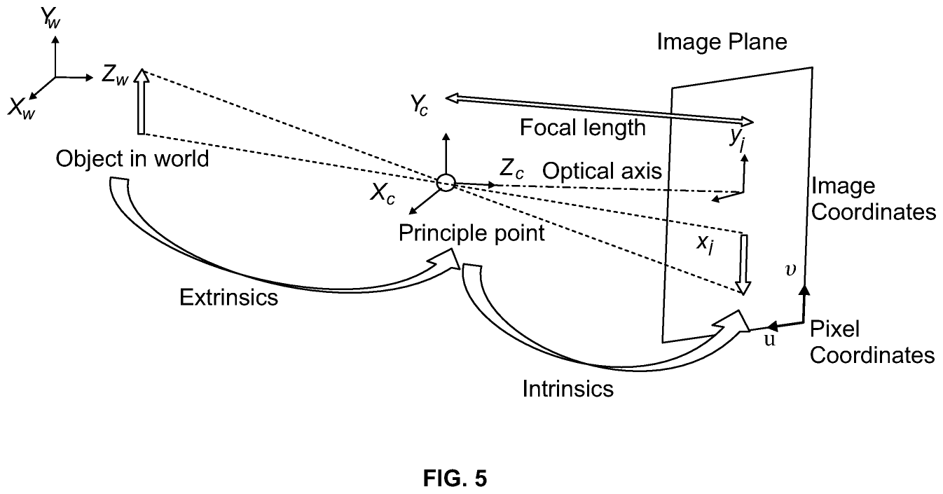

The camera is calibrated at the beginning. The camera parameters are obtained for image processing such as intrinsic, extrinsic, rotation and the re-projected image points. FIG. 4 summarizes the overall proposed procedure of finding dynamic displacement of the bridge using this algorithm with both laser and camera and using an LVDT as a validation in the end.

The camera algorithm section takes advantage of the pinhole camera model. This model enables the transmission from 2D image coordinates, to 3D world coordinates of the camera which enables to find the displacement of the camera, ultimately the drone, by choosing a reference frame. Pinhole camera model can be described as below:

$$s [ \begin{matrix}x & y & 1\end{matrix} ] = [ \begin{matrix}X & Y & Z & 1\end{matrix} ] \times [ \begin{matrix}R \\ t\end{matrix} ] K \qquad Eq ( 1 )$$

Where s is the scale factor; x, y are the image points; X, Y, Z are world points; R and t are rotation matrix and translation vector, respectively; and K is the intrinsic matrix. X, Y, Z are the parameters of interest and intrinsic and extrinsic parameters of camera and experiment could be found by a camera calibration.

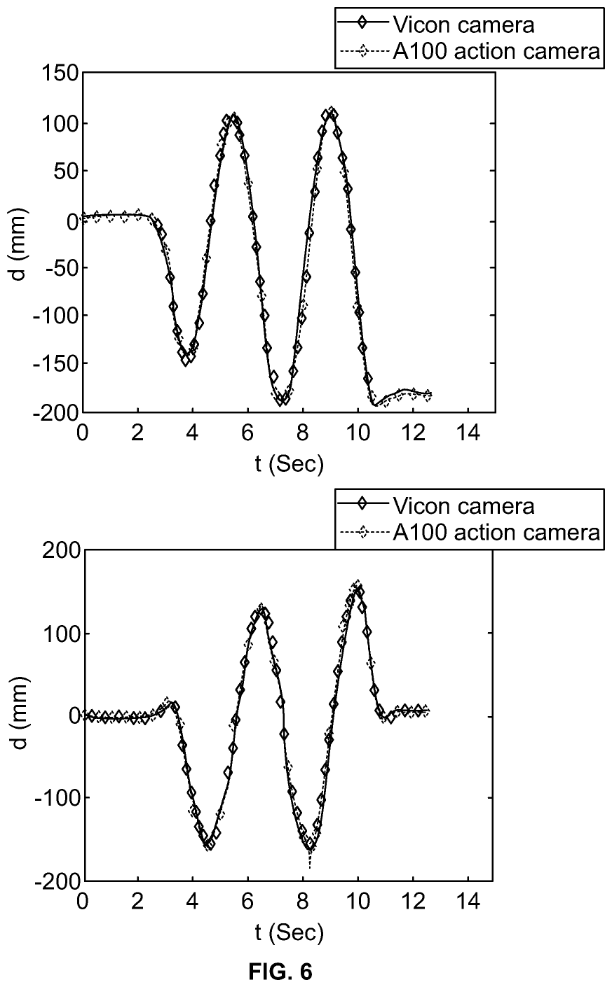

The pinhole camera model is shown in FIG. 5 and is used for video processing to find ego-motion. The pinhole camera model finds the position of camera in real world for every frame. The model then subtracts the position of the camera in consecutive frames to find the movement in each direction.

As discussed above, the embodiments of the drone shown in FIGS. 2 and 3 use 1) one or more cameras external to the drone to film the drone in order to track its movement 2) use a camera on the drone to track the movement of the drone over a predetermined surface pattern such as a checkerboard 390 which is external to the UAS (shown in FIG. 3); or 3) use both methods. A processor then uses an algorithm, as described above, to remove the hovering or movement of the drone from the distance measured by the laser from the drone to the object. Thus, the system of the present invention uses the distance obtained from the laser and takes into account the movement of the drone to determine the movement of the object.

The components of the present invention provide a system wherein information from a camera is used to find the rotational angles that a laser experiences on a hovering UAS. Also, the embodiments of the present invention provide a system wherein data from an additional accelerometer attached to a UAS may be used to find the rotational angles that a laser experiences on a hovering UAS.

The components of the present invention operate as follows:

One or more lasers that are used to determine the distance from drone to object to be measured.

One or more accelerometers that are used to determine the 6-degrees of movement a drone experiences in flight.

One or more cameras 320 are used to find the rotational angles that a laser experiences on a hovering UAS using the method described above.

At least on RGB light used to properly position the drone a predetermined distance from an object to be measured.

At least one DAQ for the laser and Accelerometer

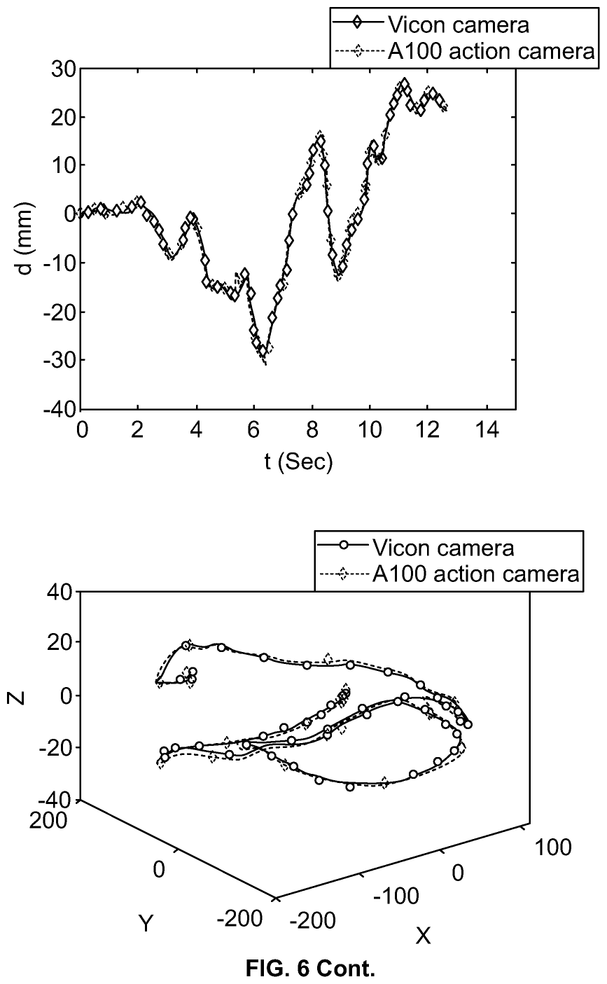

A test was conducted in a laboratory, equipped with VICON camera. VICON system is a combined group of cameras installed in a cage. The system is used for object motion capture of an object inside the cage environment with high accuracy. FIG. 6 provides a comparison between the present invention algorithm's estimation and VICON cameras' estimations (a) Displacement in X direction (b) Displacement in Y direction (c) Displacement on Z direction (d) 3D space view.

Test results shows that the estimation of the displacement is possible with mm accuracy by the proposed method the displacement errors were laboratory indoor environment with the help of advanced positioning system with millimeter accuracy for validation. FIG. 6 provides the comparison results. Percentage errors were 16.37 mm, 31.18 mm and 3.18 mm in X, Y and Z directions. Also, the percentage errors were 1.5%, 2.7%, and 3.6% in X, Y and Z directions, respectively.

The embodiments of the present invention can also measure wildlife activity with a reference-free contact-free drone that can obtain the real movement, the velocity of wildlife with the integration of laser and cameras.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A system that enables the non-contact real-time displacement of an object comprising: an UAS including at least one laser;
at least one accelerometer;
at least one processor;
wherein data from said at least one accelerometer is used by said processor to determine the 6-degrees of freedom said UAS experiences in flight; and
wherein data from said laser is used by said processor to determine the distance between said UAS and the object.

2. The system of claim 1 further including at least one camera attached to said UAS and wherein information from said at least one camera is used to correct a signal concerning the distance between the drone and object generated by the system due to the movement or hovering of said UAS.

3. The system of claim 1 further including at least one predetermined surface pattern external to said UAS and wherein information obtained from said at least one camera from said at least one predetermined surface pattern is used to correct a signal concerning the distance between the drone and object generated by the system due to the movement or hovering of said UAS.

4. The system of claim 1 further including at least one multicolored light wherein said at least one multicolored light is used to maintain said UAS in a predetermined range of distance from an object to be measured.

5. The system of claim 1 further including at least camera external to said UAS and wherein information obtained from said at least one external camera is used to correct a signal concerning the distance between the drone and object generated by the system due to the movement or hovering of said UAS.
